(19) United States
(12) Patent Application Publication
(10) Pub. No.: US 2008/0002329 A1
(43) Pub. Date: Jan. 3, 2008

(54) High Dielectric, Non-Linear Capacitor

(76) Inventors: Arthur V. Pohm, Ames, IA (US); Andrew L. Tipton, Des Moines, IA (US); Carl L. Tipton, Ames, IA (US)

Correspondence Address: ANDREW TIPTON, 320 NW UPTOWN TERRACE, UNIT 1A, PORTLAND, OR, 97210, US

(21) Appl. No.: 11/428,395

(22) Filed: Jul. 2, 2006

(51) Int. Cl. H01G 4/06

(52) U.S. Cl. 361/311

(57) ABSTRACT

A high-dielectric, non-linear capacitor is described comprising a chromophore between two electrodes.

### FIELD OF THE INVENTION

This invention relates in general to the field of capacitors, and more particularly, to high dielectric, non-linear capacitors. A capacitor is an energy storage device that stores an applied electrical charge for a period of time and then discharges it. It is charged by applying a voltage across two electrodes and discharged by shorting the two electrodes. A voltage is maintained until discharge even when the charging source is removed. A capacitor blocks the flow of direct current and permits the flow of alternating current. The energy density of a capacitor is usually less than for a battery, but the power output of a capacitor is usually higher than for a battery. Capacitors are used for various purposes including timing, power supply smoothing, coupling, filtering, tuning and energy storage. Batteries and capacitors are often used in tandem such as in a camera with a flash. The battery charges the capacitor that then provides the high power needed for a flash. The same idea works in electric and hybrid vehicles where batteries provide energy and capacitors provide power for starting and acceleration.

Two main types of capacitors are non-electrolytic and electrolytic. A non-electrolytic capacitor is non-polarized and can be connected either way in a circuit and often consists of two conductors such as parallel metal plates that are insulated from one another with a dielectric. An electrolytic capacitor is polarized and must be connected to the circuit in a specific way.

An electrochemical capacitor, also known as an electrochemical double-layer capacitor, supercapacitor or ultracapacitor, consists of high surface area electrodes separated by an ionically conductive electrolyte. The surface area of an electrode, often porous carbon, is on the order of 1000 m²/g. Most of the surface of the electrode cannot be accessed mechanically, but can be accessed by a liquid electrolyte. The energy density of an electrochemical capacitor is higher than that of traditional non-electrolytic and electrolytic capacitors, but still lower than that of a battery. Conversely, the power output of an electrochemical capacitor is lower than that of traditional non-electrolytic and electrolytic capacitors, but higher than that of a battery. Moreover, an electrochemical capacitor discharges slower than traditional non-electrolytic and electrolytic capacitors.

A need exists to improve the energy density of capacitors while maintaining the existing power output. There exists a further need to provide a capacitor featuring a high dielectric constant sustainable to high frequencies where the capacitance is voltage dependent. Such a capacitor is the subject of the present invention. The capacitor of the present invention builds on past work on non-linear optical chromophores.

In high frequency applications, it is often important that the capacitors used do not have high dielectric losses. In the case of ferroelectric ceramic capacitors with a high dielectric constant, the presence of domain boundaries and electrostriction provide loss mechanisms that are significant. In contrast, the high dielectric mechanism disclosed in this invention involves the movement of an electron in a long molecule and its fixed donor. This occurs extremely rapidly so that losses even at gigahertz frequencies are small.

A second very useful property of the type of capacitor disclosed in the invention is its non-linearity. In many applications, it is desirable to have a voltage sensitive capacitance to tune circuits and adjust filters. The disclosed capacitors have such a property; as the mobile electron moves to the far end of the chromophore as the voltage increases, its motion is stopped so that with additional voltage little change in position occurs. As a consequence, the increase in the electric moment of the dielectric is reduced resulting in a diminished dielectric constant.

### BRIEF DESCRIPTION OF THE SEVERAL VIEWS OF THE DRAWING

FIG. 1 shows a chromophore.

FIGS. 2(a) to 2(e) show preferred chromophores.

FIG. 3 shows the change in potential as the electric moment increases with applied potential.

FIG. 4 shows that the dielectric constant of a chromophore varies with voltage.

FIG. 5 shows the change in polarity of a chromophore under a bias.

FIG. 6 shows chromophores in a random orientation between electrodes.

FIG. 7 shows aligned chromophores between electrodes.

FIG. 8 shows an electrode coated with a self-assembled monolayer.

### SUMMARY OF THE INVENTION

One aspect of the present invention is to provide a capacitor with a high power output. A further aspect of the present invention is to provide a capacitor featuring a high dielectric constant sustainable to high frequencies. A still further aspect of the present invention is to provide a capacitor featuring voltage dependent capacitance. In yet another aspect of the present invention, a method to make such a capacitor is provided.

The capacitor, in its simplest form, comprises a first electrode, a second electrode and a chromophore between the first electrode and the second electrode. The chromophore further comprises an electron donor and an electron acceptor separated by a conjugated bridge. The conjugated bridge comprises one or more double bonds that alternate with single bonds in an unsaturated compound. Among the many elements that may be present in the double bond, carbon, nitrogen, oxygen and sulfur are the most preferred. The π electrons in the conjugated bridge are delocalized across the length of the bridge. When a bias is applied across the first and second electrodes, the chromophore becomes more or less polarized with electron density moving from the donor to acceptor or vice versa. When the bias is removed, the original charge distribution is restored. Typically the capacitor comprises a plurality of chromophores.

In one embodiment, a liquid or solid chromophore is placed between the first and second electrodes. A solid chromophore is, for example, pressed into a pellet and placed between the first electrode and the second electrode. The chromophore can be ground into a powder before pressing.

In another embodiment, the chromophore is dissolved or suspended in a polymer. This is termed a “guest-host” system where the chromophore is the guest and the polymer is the host. Polymer hosts include, but are not limited to, poly(methyl methacrylate), polyimides, polycarbonates and poly(ε-caprolactone). These systems are cross-linked or non-cross-linked.

In another embodiment, the chromophore is attached to a polymer. This is termed a “side-chain polymer” system. This system has the advantages over guest-host systems because high chromophore concentrations are incorporated into the polymer without crystallization, phase separation or concentration gradients. Side chain polymers include, but are not limited to, poly[4-(2,2-dicyanovinyl)-N-bis(hydroxyethyl)aniline-alt-(4,4′-methylenebis(phenylisocyanate))]urethane, poly[4-(2,2-dicyanovinyl)-N-bis(hydroxyethyl)aniline-alt-(isophoronediisocyanate)]urethane, poly(9H-carbazole-9-ethyl acrylate), poly(9H-carbazole-9-ethyl methacrylate), poly(Disperse Orange 3 acrylamide), poly(Disperse Orange 3 methacrylamide), poly(Disperse Red 1 acrylate), poly(Disperse Red 13 acrylate), poly(Disperse Red 1 methacrylate), poly(Disperse Red 13 methacrylate), poly[(Disperse Red 19)-alt-(1,4-diphenylmethane urethane)], poly(Disperse Red 19-p-phenylene diacrylate), poly(Disperse Yellow 7 acrylate), poly(Disperse Yellow 7 methacrylate), poly[(methyl methacrylate)-co-(9-H-carbazole-9-ethyl acrylate)], poly[(methyl methacrylate)-co-(9-H-carbazole-9-ethyl methacrylate)], poly[methyl methacrylate-co-(Disperse Orange 3 acrylamide)], poly[methyl methacrylate-co-(Disperse Orange 3 methacrylamide)], poly[(methyl methacrylate)-co-(Disperse Red 1 acrylate)], poly[(methyl methacrylate)-co-(Disperse Red 1 methacrylate)], poly[(methyl methacrylate)-co-(Disperse Red 13 acrylate)], poly[(methyl methacrylate)-co-(Disperse Red 13 methacrylate)], poly[methyl methacrylate-co-(Disperse Yellow 7 acrylate)], poly[methyl methacrylate-co-(Disperse Yellow 7 methacrylate)], poly [[(S)-1-(4-nitrophenyl)-2-pyrrolidinemethyl]acrylate], poly[((S)-(−)-1-(4-nitrophenyl)-2-pyrrolidinemethyl)acrylate-co-methyl methacrylate], poly [[(S)-1-(4-nitrophenyl)-2-pyrrolidinemethyl]methacrylate] and poly[((S)-(−)-1-(4-nitrophenyl)-2-pyrrolidinemethyl)methacrylate-co-methyl methacrylate]. These systems are cross-linked or non-cross-linked.

In another embodiment, the chromophore is incorporated into the polymer backbone. These systems are termed “main-chain polymer” systems. Main-chain polymers include, but are not limited to, 4-methoxy-4′-carbomethoxy-α-amino-α′-cyanostilbenes, the AB copolymer of α-cyano-m-methoxy-p-(ω-oxypropoxy)cinnamate with ω-hydroxydodecanoate, poly[(4-N-ethylene-N-ethylamino)-α-cyanocinnamate, bispheno A-4-amino-4′-nitrotolan, bisphenol A-4-nitroaniline and bisphenol A-N,N-dimethyl-4-nitro-1,2-phenylenediamine. These systems are cross-linked or non-cross-linked.

In another embodiment, the chromophore is embedded in matrices such as oxides, halides, salts and organic glasses. An example of a matrix is inorganic glasses comprising the oxides of aluminum, boron, silicon, titanium, vanadium and zirconium.

The chromophore is aligned, partially aligned or unaligned. The chromophore is preferably aligned as this results in higher capacitance values in the capacitor. The preferred method of alignment is to apply a dc electric field to the chromophore at a temperature at which the chromophore can be oriented. This method is termed “poling.” Poling is generally performed near the glass transition temperature of polymeric and glassy systems. A preferred method of poling is corona poling.

A preferred capacitor further comprises a first insulator between the first electrode and the chromophore and a second insulator between the second electrode and the chromophore. First and second insulators include, but are not limited to, organic, organometallic and inorganic insulators. Examples of insulators include metal oxides, non-metal oxides, metal hydroxides, non-metal hydroxides, metal halides, non-metal halides, metal hydrides, non-metal hydrides, self-assembled monolayers, plastics and polymers such as poly(ethylene oxide), poly(propylene oxide) and poly(vinylidene fluoride). The first and second insulators prevent or decrease tunneling between the first and second electrodes and the chromophore. In one embodiment, an insulating self-assembled monolayer is attached to an electrode. An example is octadecanethiol attached to a gold electrode with a Au(111) surface. In another embodiment, the chromophore is attached to the insulator which is attached to the electrode.

Preferred electron donors include, but are not limited to, amino and phosphino groups and combinations thereof. Preferred electron acceptors include, but are not limited to, nitro, carbonyl, oxo, thioxo, sulfonyl, malononitrile, isoxazolone, cyano, dicyano, tricyano, tetracycano, nitrile, dicarbonitrile, tricarbonitrile, thioxodihydropyrimidinedione groups and combinations thereof. More conjugated bridges include, but are not limited to, 1,2-diphenylethene, 1,2-diphenyldiazene, styrene, hexa-1,3,5-trienylbenzene and 1,4-di(thiophen-2-yl)buta-1,3-diene, alkenes, dienes, trienes, polyenes, diazenes and combinations thereof.

The first and second electrodes are selected from the group consisting of conductors and semiconductors. Conductors include, but are not limited to, metals, conducting polymers and graphite including graphene sheets. Semiconductors include, but are not limited to, silicon, germanium, silicon carbide, gallium arsenide and selenium. Preferred electrodes are copper, silver, gold, aluminum, titanium, palladium, platinum, nickel, zinc, tin, silicon and gallium arsenide. In one preferred embodiment, the electrode surface is Au(111). A Au(111) surface is preferably obtained from the evaporation of a thin gold film onto a flat support. Flat supports include, but are not limited to, glass, plastic, silicon and metal surfaces.

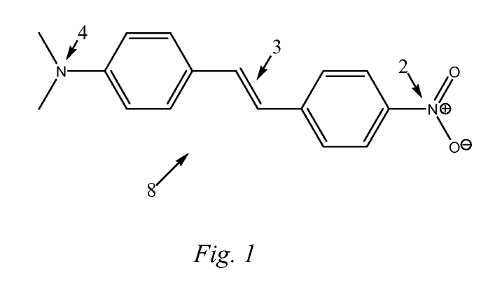

FIG. 1 illustrates the components in a chromophore 8, an electron donor 4, a conjugated bridge 3, and an electron acceptor 2. A chromophore can have more than one electron donor 4, electron acceptor 2 and conjugated bridge 3. A chromophore can comprise a mixture of molecules.

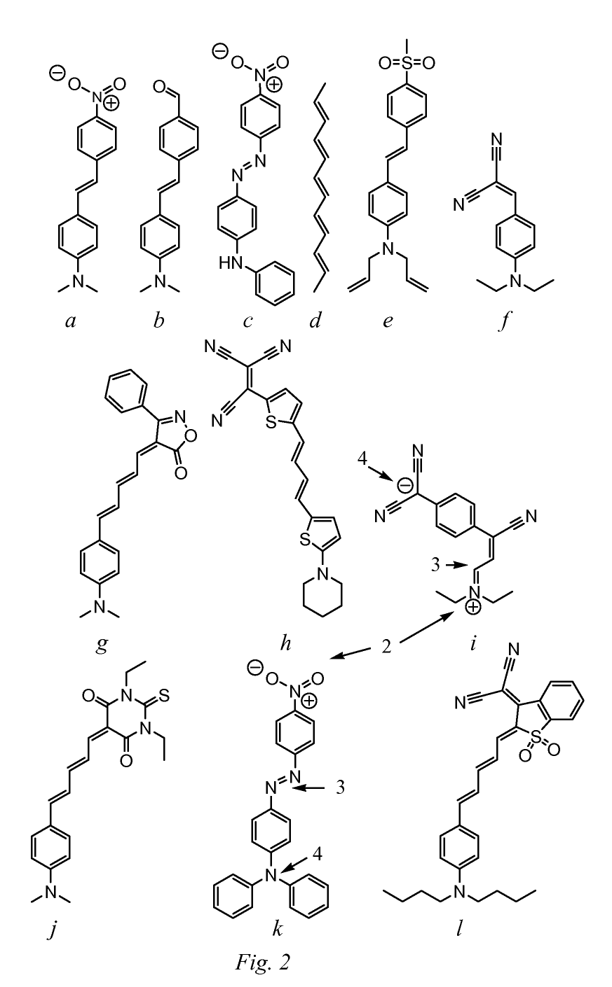

FIGS. 2(a) to (l) illustrate preferred chromophores: N,N-dimethyl-4-(4-nitrostyryl)aniline (a), 4-(4-(dimethylamino)styryl)benzaldehyde (b), 4-((4-nitrophenyl)diazenyl)-N-phenylaniline (c), dodeca-2,4,6,8,10-pentaene (d), N,N-diallyl-4-(4-(methylsulfonyl)styryl)aniline (e), 2-(4-(diethylamino)benzylidene)malononitrile (f), 4-(5-(4-(dimethylamino)phenyl)penta-2,4-dienylidene)-3-phenylisoxazol-5-one (g), 2-(5-(4-(5-(piperidin-1-yl)thiophen-2-yl)buta-1,3-dienyl)thiophen-2-yl)ethene-1,1,2-tricarbonitrile (h), dicyano(4-(1-cyano-3-(diethyliminio)prop-1-enyl)phenyl)methanide (i), 5-(5-(4-(dimethylamino)phenyl)penta-2,4-dienylidene)-1,3-diethyl-2-thioxodihydropyrimidine-4,6-dione (j), 4-((4-nitrophenyl)diazenyl)-N,N-diphenylaniline (k) and unknown name (l). Other preferred chromophores include (2,6-Dimethyl-4H-pyran-4-ylidene)malononitrile, (S)-(−)-1-(4-Nitrophenyl)-2-pyrrolidinemethanol, [4-[Bis(2-hydroxyethyl)amino]phenyl]-1,1,2-ethylenetricarbonitrile, 1-Docosyl-4-(4-hydroxystyryl)pyridinium bromide, 2-(Dimethylamino)vinyl-1-nitronaphthalene, 2,3,5,6-Tetrafluoro-7,7,8,8-tetracyanoquinodimethane, 4-[4-(Dimethylamino)styryl]-1-methylpyridinium p-toluenesulfonate, 2-[[5-(Dibutylamino)-2-thienyl]methylene]-1H-indene-1,3(2H)-di one, 2-[4-((4-(Bis(2-hydroxyethyl)amino]phenyl)(cyano)methylene]-2,5-cyclohexadien-1-ylidene]malonitrile, 2-[4-(Dimethylamino)styryl]pyridine, 2-[Ethyl[4-[2-(4-nitrophenyl)ethenyl]phenyl]amino]ethanol, 2-Amino-3-nitropyridine, 2-Amino-5-nitropyridine, 2-Aminofluorene, 2-Chloro-3,5-dinitropyridine, 2-Chloro-4-nitroaniline, 2-Methyl-4-nitroaniline, 2-Nitroaniline, 3-[(4-Nitrophenyl)azo]-9H-carbazole-9-ethanol, 3-Methyl-4-nitropyridine N-oxide, 3-Nitroaniline, 4-(Dibenzylamino)benzaldehyde-N,N-diphenylhydrazone, 4-[4-(Dimethylamino)styryl]-1-docosylpyridinium bromide, 4-[4-(Dimethylamino)styryl]pyridine, 4-Dimethylamino-4′-nitrostilbene, 4-Nitroaniline, 5-Nitroindole, 5-Nitrouracil, 7,7,8,8-Tetracyanoquinodimethane, 9-Ethyl-3-carbazolecarboxaldehyde-N-methyl-N-phenylhydrazone, Disperse Orange 25, Disperse Orange 3, Disperse Red 1, Disperse Red 13, Disperse Red 19, Disperse yellow 7, Ethyl 4-(dimethylamino)benzoate, Gentian Violet, N-(2,4-Dinitrophenyl)-L-alanine methyl ester, N,N-Dimethyl-N′-[(5-nitro-2-thienyl)methylene]-1,4-phenylenediamine, N-[3-Cyano-3-[4-(dicyanomethyl)phenyl]-2-propenylidene]-N-ethyl-ethaniminium inner salt, Nile Blue A, N-Methyl-4-nitroaniline, trans-4-[4-(Dimethylamino)styryl]-1-methylpyridinium iodide and trans-4-[4-(Dimethylamino)styryl]-1-methylpyridinium p-toluenesulfonate.

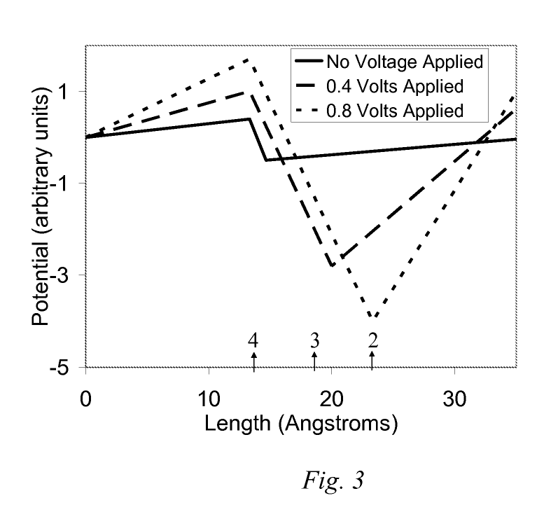

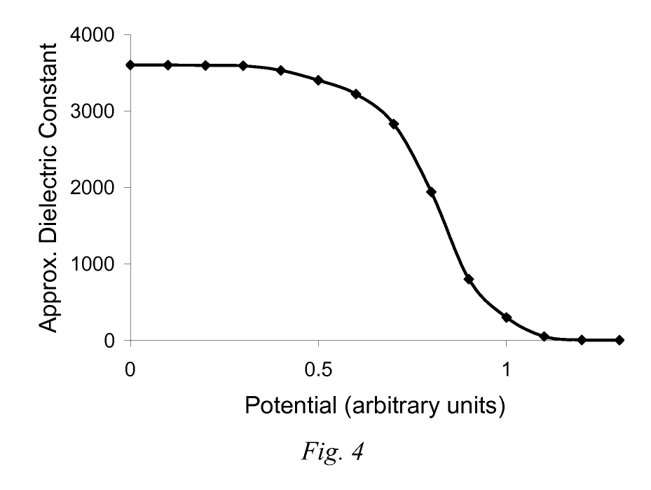

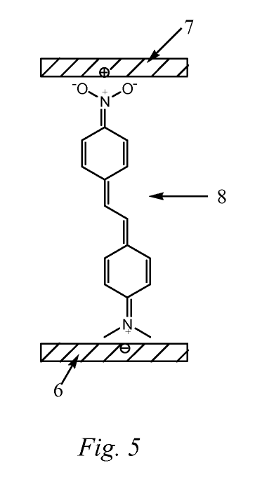

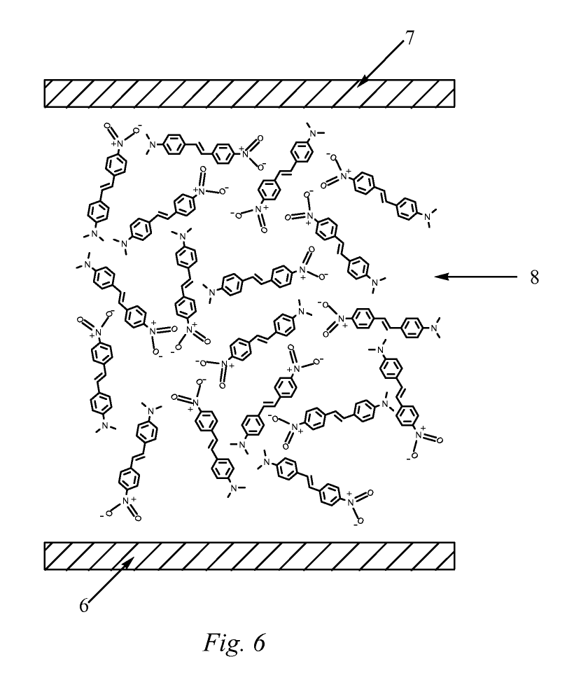

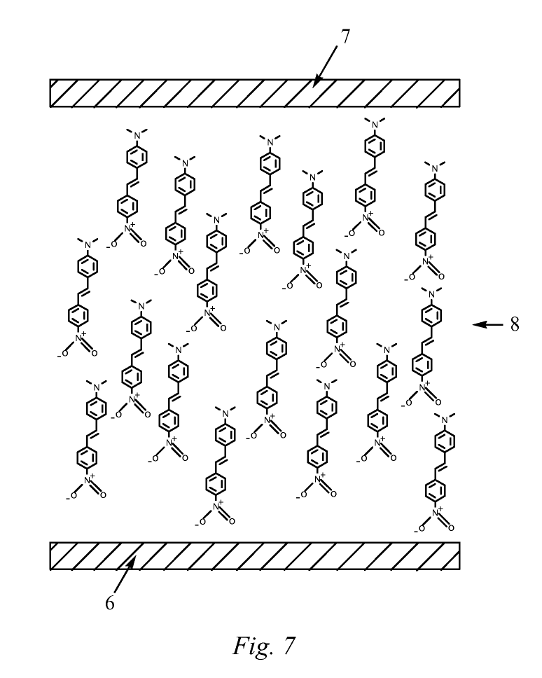

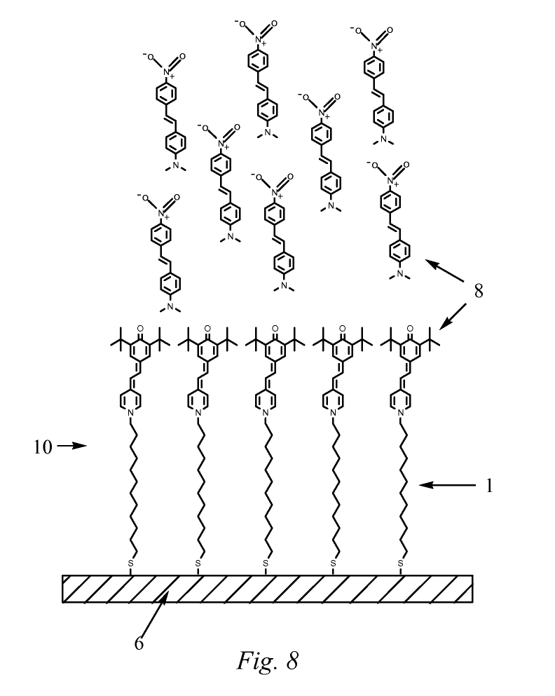

FIG. 3 illustrates the change in the potential as the electric moment increases with applied potential. A chromophore is between the first electrode 6 and the second electrode 7. The positions of the electron donor 4, the conjugated bridge 3, and the electron acceptor 2 are shown with arrows at the bottom of the Figure. The mobile electron is between the electron donor 4 and the electron acceptor 2. FIG. 4 illustrates that the dielectric constant of a chromophore varies with voltage. After the chromophore is fully polarized, the dielectric constant remains at a constant low value. FIG. 5 illustrates the change in polarity of the chromophore 8 under a bias. FIG. 6 illustrates chromophores 8 in a random orientation between the first electrode 6 and the second electrode 7. FIG. 7 illustrates aligned chromophores 8 between the first electrode 6 and the second electrode 7. FIG. 8 illustrates the first electrode 6 coated with a self-assembled monolayer 10. The monolayer 10 comprises an insulator 1 nearest the first electrode 6 and a chromophore 8 attached to the insulator 1. Additional chromophores 8 are applied onto the monolayer.

In one embodiment, the chromophore comprises more than one electron donor-conjugated bridge-electron acceptor combination in series. In another embodiment, the chromophore comprises more than one electron donor-conjugated bridge-electron acceptor combination in parallel. In yet another embodiment, the chromophore comprises electron donor-conjugated bridge-electron acceptor combinations both in parallel and in series.

What is claimed is:

1. A capacitor comprising:
a first electrode;
a second electrode; and
a chromophore between the first electrode and the second electrode, wherein the chromophore comprises an electron donor, a conjugated bridge and an electron acceptor.

2. The capacitor of claim 1 further comprising a plurality of chromophores.

3. The capacitor of claim 1 further comprising a mixture of chromophores.

4. The capacitor of claim 1 wherein the chromophore further comprises more than one electron donor-conjugated bridge-electron acceptor combination in series.

5. The capacitor of claim 1 wherein the chromophore further comprises more than one electron donor-conjugated bridge-electron acceptor combination in parallel.

6. The capacitor of claim 1 wherein the chromophore further comprises more than one electron donor-conjugated bridge-electron acceptor combination in series and in parallel.

7. The capacitor of claim 1 wherein the conjugated bridge is selected from the group consisting of alkenes, dienes, trienes, polyenes, 1,2-diphenylethene, 1,2-diphenyldiazene, styrene, hexa-1,3,5-trienylbenzene, 1,4-di(thiophen-2-yl)buta-1,3-diene and combinations thereof.

8. The capacitor of claim 1 wherein the electron donor is selected from the group consisting of amino, phosphino groups and combinations thereof.

9. The capacitor of claim 1 wherein the electron acceptor is selected from the group consisting of nitro, carbonyl, oxo, thioxo, sulfonyl, malononitrile, isoxazolone, cyano, dicyano, tricyano, tetracycano, nitrile, dicarbonitrile, tricarbonitrile, thioxodihydropyrimidinedione groups and combinations thereof.

10. The capacitor of claim 1 wherein the electron donor is an amino group, the electron acceptor is selected from the group consisting of nitro, carbonyl and cyano groups and the conjugated bridge is selected from the group consisting of alkenes, diphenyldiazene, 1,2-diphenylethene and combinations thereof.

11. The capacitor of claim 1 wherein the capacitor features a high dielectric constant sustainable to high frequencies and the capacitance is voltage sensitive.

12. A multilayer capacitor comprising a plurality of layers wherein each layer comprises a chromophore between a first electrode and a second electrode.
